(19) United States
(12) Patent Application Publication
(10) Pub. No.: US 2024/0428055 A1
(43) Pub. Date: Dec. 26, 2024

(54) QUANTIZATION AWARE TRAINING METHOD, AND MEDIUM AND CONVOLUTIONAL NEURAL NETWORK

(71) Applicant: HANGHOU SUPERACME MICROELECTRONICS TECHNOLOGY CO., LTD., Hangzhou (CN)

(72) Inventors: Min Yang, Hangzhou (CN); Guo Ai, Hangzhou (CN); Zuoxing Yang, Hangzhou (CN); Ruming Fang, Hangzhou (CN); Zhihong Xiang, Hangzhou (CN)

(21) Appl. No.: 18/703,990

(22) PCT Filed: Oct. 13, 2022
(86) PCT No.: PCT/CN2022/125122

§ 371 Date: Apr. 23, 2024

(30) Foreign Application Priority Data
Nov. 5, 2021 (CN) 202111304007.9

(51) Int. Cl. G06N 3/0464; G06N 3/045; G06N 3/082

(52) U.S. Cl. CPC G06N 3/0464; G06N 3/045; G06N 3/082

(57) ABSTRACT

The present application discloses a method, apparatus, device, medium and convolutional neural network for quantization aware training. The method is performed by electronic equipment and includes: performing sample training on a first convolutional neural network, wherein at least one convolution layer of the first convolutional neural network includes a mergeable branch structure and at least one first shortcut; reserving the at least one first shortcut in the at least one convolution layer of trained first convolutional neural network; merging the mergeable branch structure except the at least one first shortcut in the at least one convolution layer, and obtaining a second convolutional neural network having a first shortcut structure; and, performing quantization aware training based on the second convolutional neural network to improve accuracy of quantization of the convolutional neural network model.

### CROSS-REFERENCE TO RELATED APPLICATIONS

This application is a national stage application of International Patent Application No. PCT/CN2022/125122 filed Oct. 13, 2022, entitled “Quantitative-Aware Training Method and Apparatus, and Device, Medium and Convolutional Neural Network”, which claims the priority to Chinese Patent Application No. 202111304007.9, entitled “Quantitative Aware Training Method of Convolutional Neural Network and Convolutional Neural Network Structure” and filed on Nov. 5, 2021, the contents of which are incorporated by reference herein in their entirety for all intended purposes.

### FIELD OF THE TECHNOLOGY

The present application relates to the field of machine learning, and in particular, to a method, apparatus, device, medium, and convolutional neural network for quantization aware training.

### BACKGROUND OF THE INVENTION

Convolutional Neural Networks (CNNs) has been widely used in visual tasks because of its high accuracy. In order to achieve higher accuracy, a convolutional neural network with a multi-branch structure is used in training and may in this way be made very complicated. In reasoning, multiple branches can be merged into a single branch, which can reduce occupation of storage space and speed up reasoning. Typical convolutional neural networks with a mergeable branch structure are RepVGG, DBB, etc.

In order to further save storage space and speed up reasoning, it is generally necessary to quantize a convolutional neural network model, so as to update model parameters of high-precision floating-point numbers to those of low-precision integers. For example, weights and activations represented with floating-point numbers are approximately represented by low-precision integers, so that a low-bit convolutional neural network model can be obtained. Quantization aware training is one of model quantization techniques, and updates and optimizes parameters through an effect of network simulation quantization in a training process.

For a convolutional neural network with a mergeable branch structure used in training, if quantization aware training is directly performed on it, because current quantization aware training is made for each convolution, there will be additional quantization parameters in training, and a parameter of each branch may be different, which results in that multiple branches cannot be merged into a single branch after quantization. Accordingly, an existing quantization aware training method is to perform quantization aware training after the multiple branches are merged into a single branch. Moreover, model parameters of the convolutional neural network obtained based on quantization aware training of a convolutional neural network of a single-branch structure are not accurate.

### SUMMARY OF THE INVENTION

The present application provides a method, apparatus, equipment, medium, and convolutional neural network for quantization aware training, so as to perform quantization aware training on a convolutional neural network under a multi-branch structure.

The present application provides a quantization aware training method for a convolutional neural network to be executed by electronic equipment, including:
performing sample training on a first convolutional neural network, wherein at least one convolution layer of the first convolutional neural network includes a mergeable branch structure and at least one first shortcut;
reserving the at least one first shortcut in the at least one convolution layer of trained first convolutional neural network, and merging the mergeable branch structure except the at least one first shortcut in the at least one convolution layer, and obtaining a second convolutional neural network having a first shortcut structure; and performing quantization aware training based on the second convolutional neural network.

In another aspect of the present application, provided is a quantization aware training apparatus for a convolutional neural network, including:
a sample training module, to perform sample training on a first convolutional neural network, wherein at least one convolution layer of the first convolutional neural network includes a mergeable branch structure and at least one first shortcut structure;
a branch merging module, to reserve the at least one first shortcut in the at least one convolution layer of trained first convolutional neural network, and merge the mergeable branch structure except the at least one first shortcut in the at least one convolution layer, and obtain a second convolutional neural network having a first shortcut structure; and a quantization aware training module, to perform quantization aware training based on the second convolutional neural network.

The present application also provides a convolutional neural network structure for quantization aware training, including at least one convolution layer in which:
an output result of a previous convolution layer adjacent to this convolution layer is taken as at least one first shortcut of this convolution layer and connected to an input of a first accumulation operation of this convolution layer, an output of an activation function operation of this convolution layer is connected to another input of the first accumulation operation of this convolution layer, and a result of the first accumulation operation is input to a next convolution layer adjacent to this convolution layer;
wherein the at least one first shortcut is: a shortcut reserved in merging a mergeable branch structure in sample-trained first convolutional neural network, wherein at least one convolution layer of the first convolutional neural network comprises the mergeable branch structure.

According to yet another aspect of embodiments of the present application, provided is also a computer-readable storage medium including a stored program therein, wherein the program, when executed by a computer, executes the above method.

According to yet another aspect of embodiments of the present application, provided is a computer program product, including a computer program/instructions, wherein the computer program/instructions, when executed by a processor, realize the above method.

According to yet another aspect of embodiments of the present application, provided is also electronic device including a memory having a computer program stored therein and a processor configured to perform the method by running the computer program.

According to the quantization aware training method for a convolutional neural network provided by the present application, since there is a shortcut in a convolution layer with a same input data dimension and output data dimension, quantization aware training does not need to be performed based on a convolutional neural network with a single branch structure, which is beneficial to improving accuracy of model parameters of the convolutional neural network, so that a better training effect can be achieved in the quantization aware training.

### BRIEF DESCRIPTION OF THE DRAWINGS

FIG. 1 is a schematic diagram illustrating a quantization aware training method for a convolutional neural network of the present application.

FIGS. 2a and 2b are schematic diagrams illustrating a convolutional neural network structure according to an embodiment of the present application.

FIGS. 3a and 3b are schematic diagrams illustrating performing of quantization aware training on a RepVGG convolutional neural network structure according to an embodiment of the present application.

FIGS. 4a and 4b are schematic diagrams illustrating another convolutional neural network having a shortcut structure according to an embodiment of the present application.

FIGS. 5a and 5b are schematic diagrams illustrating a convolutional neural network structure according to another embodiment of the present application.

FIGS. 6a and 6b are schematic diagrams illustrating performing of quantization aware training on a RepVGG convolutional neural network structure according to yet another embodiment of the present application.

FIG. 7 is a schematic diagram illustrating a quantization aware training apparatus for a convolutional neural network according to an embodiment of the present application.

FIG. 8 is a schematic diagram illustrating a structure of electronic device according to an embodiment of the present application.

### EMBODIMENTS OF THE INVENTION

In order to make the purpose, technical means and advantages of the present application more clear, the present application will be further described in detail in conjunction with the drawings.

The applicant found through research: a shortcut is a very effective structure in the development of convolutional neural networks, and can transfer an output of one operator to input of another operator without any processing, thus making less information loss; and, in terms of feature mapping, a convolutional neural network model having a shortcut structure has better accuracy than a convolutional neural network model having no shortcut structure, which means that a shortcut is very important for an effect of quantization aware training.

In view of this, the applicant proposed that in a convolutional neural network, if an input data dimension of a convolution layer is the same as an output data dimension, a shortcut is added to the convolution layer and quantization aware training is performed based on a convolutional neural network of a multi-branch structure, or an existing shortcut of the convolution layer is reserved and quantization aware training is performed based on the convolutional neural network of a multi-branch structure.

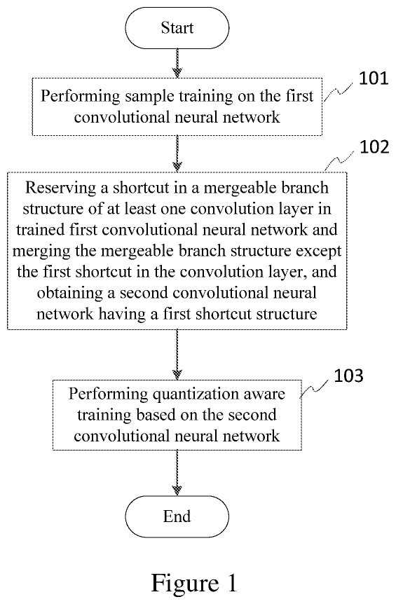

Referring to FIG. 1, which is a schematic diagram of a quantization aware training method for a convolutional neural network according to embodiments of the present application, the method includes the following steps.

In step 101, sample training is performed on a first convolutional neural network, wherein at least one convolution layer of the first convolutional neural network includes a mergeable branch structure and at least one first shortcut.

Sample data used in the sample training may be various required sample data, for example, for a convolutional neural network used for image target detection, the sample data may be image data, such as image frames; for a convolutional neural network used for text detection, the sample data may be text data, such as text with text coding information; and for a convolutional neural network used for sound detection, the sample data may be sound data, such as signals with different frequency bands and different amplitudes.

In step 102, the at least one first shortcut is reserved in the at least one convolution layer of the trained first convolutional neural network, and the mergeable branch structure except the at least one first shortcut in the at least one convolution layer is merged, and then a second convolutional neural network having a first shortcut structure is obtained.

The at least one first shortcut reserved in the at least one convolution layer is an added shortcut; and/or the at least one first shortcut reserved in the at least one convolution layer is an existing shortcut in the mergeable branch structure.

In step 103, quantization aware training is performed based on the second convolutional neural network.

In the present application, a convolutional neural network of a multi-branch structure is obtained by making a first shortcut exist in a convolution layer, and quantization aware training is performed based on the convolutional neural network of a multi-branch structure, which is beneficial to improving an effect of quantization of the convolutional neural network model.

With the quantization-aware-trained convolutional neural network model according to the present application, a convolutional neural network chip may be designed, which makes a computing unit in the convolutional neural network chip reduce a number of bits to be processed while having better data accuracy and is thus beneficial to reducing the consumption of hardware computing power and saving hardware resources.

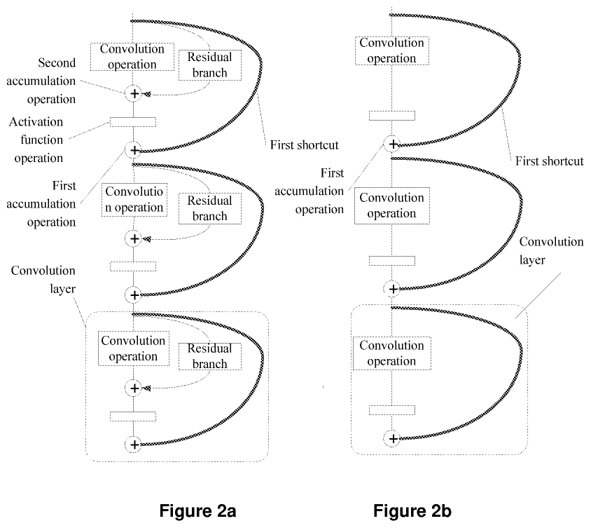

Referring to FIGS. 2a and 2b, which are schematic diagrams illustrating a convolutional neural network structure according to an embodiment of the present application, FIG. 2a is a multi-branch convolutional neural network structure used for sample training, and FIG. 2b is a convolutional neural network structure used for quantization aware training.

As shown in FIG. 2a, any i^{th} convolution layer with a same input data dimension and output data dimension includes a convolution operation, an activation function operation (ReLU), a second accumulation operation, a first accumulation operation, a residual branch and a first shortcut.

The first shortcut is an added shortcut.

An input of the convolution operation, an input of the residual branch and an input of the first shortcut are from an output of the first accumulation operation in an (i−1)^{th} convolution layer.

A result output from the convolution operation and a result output from the residual branch are input to the second accumulation operation.

A result output from the second accumulation operation is input to the activation function operation.

A result output from the activation function operation and the first shortcut are input to the first accumulation operation.

A result output from the first accumulation operation is input to convolution operation, residual branch and first shortcut in the (i+1)^{th} convolution layer respectively, that is, the convolution operation and the residual branch in the i^{th} convolution layer are connected between the output of the first accumulation operation in the (i−1)^{th} convolution layer and the input of the second accumulation operation in the i^{th} convolution layer; the first shortcut in the i^{th} convolution layer is connected between the output of the first accumulation operation in the (i−1)^{th} convolution layer and the input of the first accumulation operation in the i^{th} convolution layer; and an activation function operation is connected between the output of the second accumulation operation in the i^{th} convolution layer and the input of the first accumulation operation in the i^{th} convolution layer. The residual branch is a mergeable branch structure.

Sample data is input to a convolutional neural network of a multi-branch structure (a first convolutional neural network) for sample training, and a floating-point model with full-precision floating-point parameters is obtained.

In this embodiment, in order to reserve a shortcut in the model for quantization aware training, a residual branch of each convolution layer is merged; and for the first shortcut, in view of the fact that the first shortcut crossing the activation function operation is used when adding the first shortcut, in order to facilitate the consistency of a reasoning result with a sample training result and improve accuracy of subsequent quantization aware training, the first shortcut is reserved, and thus a convolutional neural network with a first shortcut structure in each convolution layer is obtained. The convolutional neural network is still a floating-point model with full-precision floating-point parameters, and as shown in FIG. 2b, any i^{th} convolution layer with a same input data dimension and output data dimension includes a convolution operation, an activation function operation (ReLU), a first accumulation operation and a first shortcut.

A convolution operation in the i^{th} convolution layer is connected between the output of the first accumulation operation in the (i−1)^{th} convolution layer and the input of the activation function operation in the i^{th} convolution layer.

The first shortcut in the i^{th} convolution layer is connected between the output of the first accumulation operation in the (i−1)^{th} convolution layer and the input of the first accumulation operation in the i^{th} convolution layer.

The output of the activation function operation in the i^{th} convolution layer is connected to the input of the first accumulation operation in the i^{th} convolution layer.

The convolutional neural network having the first shortcut is taken as a pre-training model for quantization aware training, and then an integer model with low-bit integers is obtained.

For ease of understanding, explanation is made by taking the RepVGG as an example.

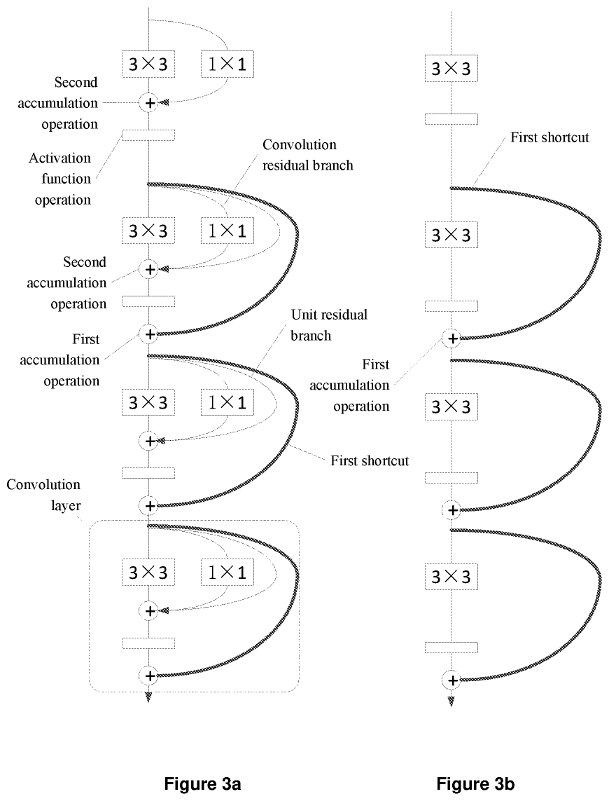

Referring to FIGS. 3a and 3b, which are schematic diagrams illustrating performing quantization aware training on a RepVGG convolutional neural network structure according to the present application, FIG. 3a is a multi-branch convolutional neural network used for sample training, and FIG. 3b is a convolutional neural network used for quantization aware training.

As shown in FIG. 3a, an input data dimension of a first convolution layer is different from an output data dimension, so a first shortcut is not added in the convolution layer, and a unit residual branch is not included in the convolution layer, wherein input data is input into a convolution operation in the convolution layer and into a convolution residual branch in the convolution layer, a result of the convolution operation and a result output from the convolution residual branch are input into a second accumulation operation, a result of the second accumulation operation is input into an activation function of the convolution layer, and a result output from the activation function is input into a second convolution layer.

For the remaining convolution layers, if an input data dimension of each convolution layer is the same as the output data dimension, the convolution layer includes a convolution operation, an activation function operation (ReLU), a second accumulation operation, a first accumulation operation, a convolution residual branch, a unit residual branch, and a first shortcut.

An input of the convolution operation, an input of the convolution residual branch, an input of the unit residual branch, and an input of the first shortcut in this convolution layer are from an output of the first accumulation operation in the previous convolution layer adjacent to this convolution layer.

An output of the convolution operation, an output of the convolution residual branch, and an output of the unit residual branch are input to the second accumulation operation.

The output of the second accumulation operation is input to the activation function operation.

An output of the activation function operation and the first shortcut are input to the first accumulation operation.

An output of the first accumulation operation is input to the convolution operation, the convolution residual branch, the unit residual branch, and the first shortcut in a next convolution layer.

The convolution residual branch and the unit residual branch are mergeable branch structures, wherein the unit residual branch may be understood as a second shortcut.

As shown in FIG. 3b, in the first convolution layer, after the convolution residual branch is merged as a mergeable branch structure, a result of the convolution operation in the first convolution layer is input to the activation function and a result output from the activation function is input to a second convolution layer; in the second convolution layer, the result output from the activation function in the first convolution layer (i.e., an input to the second convolution layer) is connected to input of the first accumulation operation in the second convolution layer through a first shortcut in the second convolution layer; for the remaining convolution layers except the first convolution layer and the second convolution layer, if an input data dimension of each convolution layer is the same as the output data dimension, each convolution layer includes a convolution operation, an activation function operation (ReLU), a first accumulation operation, and a first shortcut.

The convolution operation of this convolution layer is connected between the output of the first accumulation operation in a previous convolution layer and the input of the activation function operation in this convolution layer.

The first shortcut of this convolution layer is connected between the output of the first accumulation operation in the previous convolution layer and the input of the first accumulation operation in this convolution layer.

Output of the activation function operation in this convolution layer is connected to the input of the first accumulation operation in this convolution layer.

The quantization aware training includes the following processes.

Firstly, sample training is performed based on a convolutional neural network of a multi-branch structure, i.e., the network structure shown in FIG. 3a, then a floating-point model with full precision floating-point parameters is obtained.

Then, for each convolution layer, a residual branch of the convolution layer is merged and an added first shortcut is reserved, then a convolutional neural network having the first shortcut, i.e., the network structure shown in FIG. 3b, is obtained.

Finally, the convolutional neural network having the first shortcut is taken as a pre-training model for quantization aware training, and then an integer model with low-bit integers is obtained.

Quantization aware training with 2-bit weights and 8-bit activations is performed on the RepVGG neural network, and experiments show that accuracy of the neural network before improvement is 63.7, and accuracy of the neural network after the improvement is 68.95.

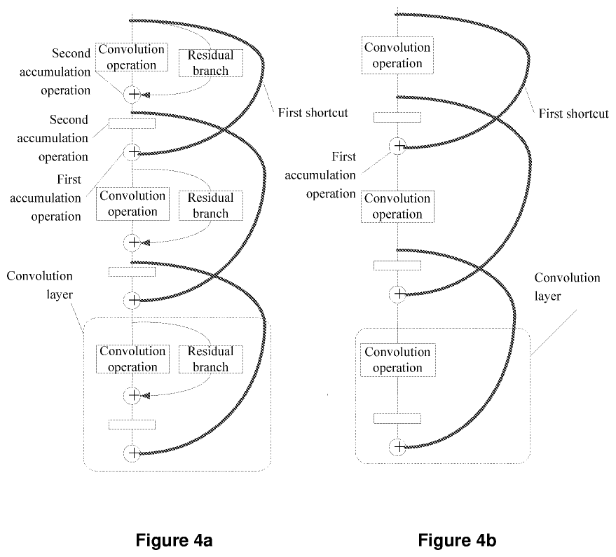

As a variation, the first shortcut added to the convolutional neural network may also be shown in FIGS. 4a and 4b. FIGS. 4a and 4b are schematic diagrams illustrating another convolutional neural network structure having a first shortcut branch structure according to an embodiment of the present application, FIG. 4a is a multi-branch convolutional neural network used for sample training, and FIG. 4 b is a convolutional neural network used for quantization aware training.

As shown in FIG. 4a, in each convolution layer, a connection relationship of the convolution operation, the activation function operation, the second accumulation operation, the first accumulation operation, and the residual branch is the same as that in FIG. 2a, but there is a difference that a first shortcut in the i^{th} convolution layer is connected between the output of the second accumulation operation in the (i−1)^{th} convolution layer and the input of the first accumulation operation in the i^{th} convolution layer.

As shown in FIG. 2b, in each convolution layer, a connection relationship of the convolution operation, the activation function operation (ReLU), and the first accumulation operation is the same as that in FIG. 2b, but there is a difference that the first shortcut in the i^{th} convolution layer is connected between the output of the first convolution operation (i.e., the input of the activation function operation) in the (i−1)^{th} convolution layer and the input of the first accumulation operation in the i^{th} convolution layer.

In this embodiment, a mergeable branch structure may include a second shortcut, or may not include any shortcut. If there is the second shortcut, the second shortcut may be merged or reserved in quantization aware training.

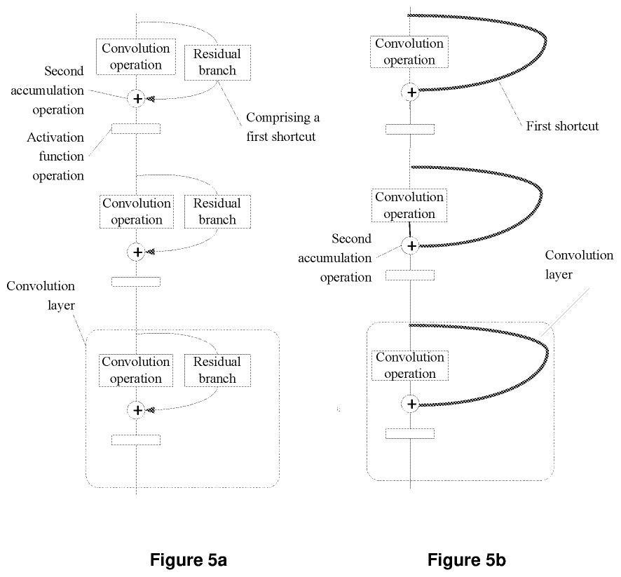

Referring to FIGS. 5a and 5b, which are schematic diagrams illustrating a convolutional neural network structure according to another embodiment of the present application, FIG. 5a is a multi-branch convolutional neural network structure used for sample training, and FIG. 5b is a convolutional neural network structure used for quantization aware training.

As shown in FIG. 5a, any i^{th} convolution layer with a same input data dimension and output data dimension includes a convolution operation, an activation function operation (ReLU), a second accumulation operation and a residual branch.

The residual branch includes at least one shortcut, which is referred to as a first shortcut for the convenience of description hereinafter.

A result of the convolution operation in the i^{th} convolution layer is input to the second accumulation operation, an output from the activation function operation in the (i−1)^{th} convolution layer is input to the second accumulation operation through the residual branch, an output from the second accumulation operation is input to the activation function operation, and an output from the activation function operation is input to the convolution operation in the (i+1)^{th} convolution layer and the residual branch in the (i+1)^{th} convolution layer.

The residual branch is a mergeable branch structure.

Sample data is input into the convolutional neural network structure of a multi-branch structure (a first convolutional neural network), and a trained first convolutional neural network is obtained.

The first shortcut is reserved, and a mergeable branch structure except the first shortcut in the convolution layer is merged, and a convolution neural network structure (a second convolution neural network) having the first shortcut structure is obtained. As shown in FIG. 5b, any i^{th} convolution layer with a same input data dimension and output data dimension includes a convolution operation, an activation function operation (ReLU), a second accumulation operation and a first shortcut. Wherein:

A convolution operation of the i^{th} convolution layer is connected between the output of the activation function operation in the (i−1)^{th} convolution layer and the input of the second accumulation operation in the i^{th} convolution layer.

The first shortcut in the i^{th} convolution layer is connected between the output of the activation function operation in the (i−1)^{th} convolution layer and the input of the second accumulation operation in the i^{th} convolution layer.

The output of the second accumulation operation in the i^{th} convolution layer is connected to the input of the activation function operation in the i^{th} convolution layer.

The convolutional neural network having the first shortcut is taken as a pre-training model for quantization aware training, and then an integer model with low-bit integers is obtained.

For ease of understanding, the RepVGG is taken as an example.

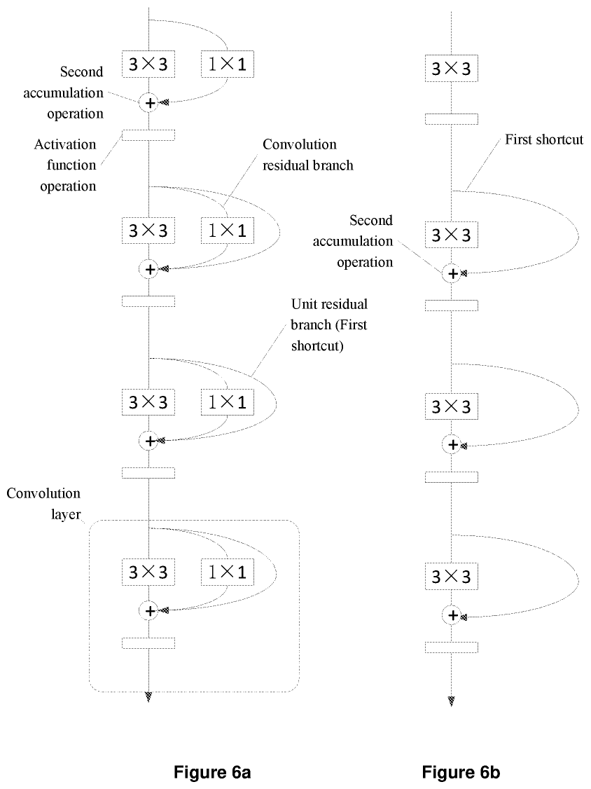

Referring to FIGS. 6a and 6b, which are schematic diagrams illustrating a RepVGG convolutional neural network structure according to yet another embodiment of the present application, FIG. 6a is a multi-branch convolutional neural network used for sample training, and FIG. 6b is a convolutional neural network used for quantization aware training.

As shown in FIG. 6a, an input data dimension of a first convolution layer is different from the output data dimension of the first convolution layer, so there is no unit residual branch in this convolution layer. In each of other convolution layers, an input data dimension is the same as the output data dimension, so each of the other convolution layers includes a convolution operation, an activation function operation (ReLU), a second accumulation operation, a convolution residual branch and a unit residual branch.

A result of the convolution operation in the i^{th} convolution layer is input to the second accumulation operation, results output from the (i−1)^{th} convolution layer are input to the second accumulation operation through the convolution residual branch and the unit residual branch, a result output from the second accumulation operation is input to the activation function operation, and a result output from the activation function operation is respectively input to the convolution operation, the convolution residual branch and the unit residual branch in the (i+1)^{th} convolution layer.

The convolution residual branch and the unit residual branch are mergeable branch structures, wherein the unit residual branch is the first shortcut.

As shown in FIG. 6b, in a first convolution layer, an input data dimension is different from the output data dimension, so there is no first shortcut in this convolution layer. In each of other convolution layers, an input data dimension is the same as the output data dimension, so each of the other convolution layers includes a convolution operation, an activation function operation (ReLU), a second accumulation operation and a first shortcut.

A convolution operation of this convolution layer is connected between the output of the activation function operation in a previous convolution layer and the input of the second accumulation operation in this convolution layer.

A first shortcut of this convolution layer is connected between the output of the activation function operation in the previous convolution layer and the input of the second accumulation operation in this convolution layer.

The output of the second accumulation operation in this convolution layer is connected to the input of the activation function operation in this convolution layer.

The quantization aware training includes the following processes.

Firstly, sample training is performed based on a convolutional neural network of a multi-branch structure, i.e., the network structure shown in FIG. 6a, and a floating-point model with full precision floating-point parameters is obtained.

Then, for each convolution layer, the first shortcut is reserved, and the residual branches of the convolution layer except the first shortcut are merged, and a convolutional neural network (a second convolutional neural network) having the first shortcut structure is obtained.

Finally, the convolutional neural network having the first shortcut is taken as a pre-training model for quantization aware training, and then an integer model with low-bit integers is obtained.

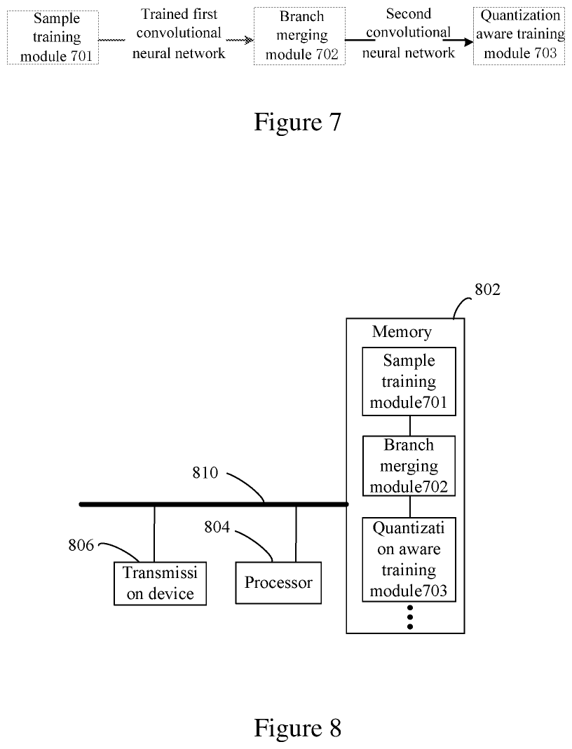

Referring to FIG. 7, which is a schematic diagram illustrating a quantization aware training apparatus for a convolutional neural network according to an embodiment of the present application, the apparatus includes the following modules.

A sample training module 701, configured to perform sample training on a first convolutional neural network. Each convolution layer of the first convolutional neural network includes a mergeable branch and at least one first shortcut.

A branch merging module 702, configured to reserve the at least one first shortcut in each convolution layer of the trained first convolutional neural network, and merging a mergeable branch structure except the first shortcut to obtain a second convolutional neural network having a first shortcut structure.

A quantization aware training module 703, configured to perform quantization aware training based on the second convolutional neural network.

For an embodiment of the apparatus/network-side device/storage medium, because it is substantially similar to the embodiments of the method, it is described relatively simply, and part of the description of the embodiments of the method is referred to for relevant points.

Referring to FIG. 8, which is a schematic diagram illustrating a structure of an electronic device according to an embodiment of the present application. The electronic device is used for implementing the above quantization aware training method for a convolutional neural network. As shown in FIG. 8, the electronic device includes a memory 802 in which a computer program is stored and a processor 804 configured to perform the processes in any one of the above embodiments of the method by running the computer program.

In this embodiment, the above processor 804 may be configured to perform the following steps by running the computer program.

In step 101, sample training is performed on a first convolutional neural network, wherein at least one convolution layer of the first convolutional neural network includes a mergeable branch structure and at least one first shortcut.

In step 102, the at least one first shortcut is reserved in the at least one convolution layer of trained first convolutional neural network, and a mergeable branch structure except the first shortcut in the at least one convolution layer is merged, and a second convolutional neural network having a first shortcut structure is obtained.

In step 103, quantization aware training is performed based on the second convolutional neural network.

The above embodiments of the method may be referred to for other details, which will not be described again here.

It may be understood by those skilled in the art that the structure shown in FIG. 8 is only schematic, and the electronic device may be in a network-side device. FIG. 8 does not limit the above structure of the electronic device. For example, the electronic device may also include more or fewer components (such as a network interface, etc.) than those shown in FIG. 8, or have a different configuration from that shown in FIG. 8.

In the electronic device, the memory 802 may be used to store a software program and a module, such as program instructions/modules corresponding to the quantization aware training method and apparatus for a convolutional neural network in the embodiments of the present application. The processor 804 performs various functional applications and data processing by running the software program and the module stored in the memory 802, that is, realizes the above quantization aware training method for a convolutional neural network. The memory 802 may include a high-speed random access memory, and may also include a non-volatile memory, such as one or more magnetic storage device, flash memory, or other non-volatile solid-state memory. In some embodiments, the memory 802 may further include memories located remotely from the processor 804, and these remote memories may be connected to the electronic device through a network. Examples of the above network include, but are not limited to, the Internet, an intranet, a local area network, a mobile communication network, and combinations thereof. As an example, as shown in FIG. 8, the memory 802 may include, but is not limited to including, the sample training module 701, the branch merging module 702 and the quantization aware training module 703 in the above quantization aware training apparatus for a convolutional neural network.

The electronic device may further include a transmission device 806 for receiving or transmitting data via a network. Specific examples of the above network may include a wired network and wireless network. In one example, the transmission device 806 includes a Network Interface Controller (NIC), which may be connected to a router through a network cable and other network apparatuses, so as to communicate with the Internet or a local area network. In one example, the transmission device 806 is a Radio Frequency (RF) module, which is used to communicate with the Internet in a wireless manner.

In addition, the above electronic device also includes a connection bus 810 for connecting various module components in the above electronic equipment.

In this embodiment, those skilled in the art can understand that all or some of the steps in the various methods of the above embodiment may be completed by instructing hardware related to the electronic device through a program, which may be stored in a computer-readable storage medium. The storage medium may include a flash disk, a Read-Only Memory (ROM), a Random Access Memory (RAM), a magnetic disk, an optical disk, or the like.

If integrated modules in the above embodiments are implemented in the form of software functional units and sold or used as independent products, they may be stored in the above computer-readable storage medium. Based on such understanding, a substantial part or a part contributes to the prior art of the technical solution of the present application or all or part of the technical solution may be embodied in the form of a computer software product, which is stored in a storage medium and includes several instructions to cause one or more computer devices (which may be personal computers, servers, network devices, or the like) to perform all or some of the steps of the methods described in the various embodiments of the present application.

In the above embodiments, it should be understood that not every convolution layer has a mergeable branch structure, and not every convolution layer has a first shortcut, wherein only one convolution layer having a first shortcut and a merged branch structure is necessary. In addition, the mergeable branch structure and the first shortcut may be in different convolution layers, respectively. In the description, the relational term such as “first” and “second” is only used to distinguish one entity or operation from another entity or operation without necessarily requiring or suggesting any such actual relationship or order between these entities or operations. Moreover, the term of “include,” “including,” “comprise,” “comprising,” or any other variation thereof is intended to cover non-exclusive inclusion, so that a process, method, article or equipment including a series of elements includes not only those elements, but also other elements not explicitly listed or elements inherent to such process, method, article or device. Without further limits, an element defined by the phrase “including a . . . ” does not exclude the existence of other identical element in the process, method, article or equipment including the element.

It should be understood that, as configured herein, unless the context clearly supports exceptions, the singular forms “a” (“a”, “an”, “the”) are intended to include the plural forms. It should also be understood that, “and/or” configured herein is intended to include any and all possible combinations of one or more of the associated listed items.

The above is only preferred embodiments of the present application, and it is not for limiting the present application. Any modification, equivalent substitution, improvement, etc. made within the spirit and principle of the present application should be included in the scope of protection of the present application.

1. A quantization aware training method for a convolutional neural network to be executed by an electronic device, the method comprising:
performing sample training on a first convolutional neural network, wherein at least one convolution layer of the first convolutional neural network comprises a mergeable branch structure and at least one first shortcut;
reserving the at least one first shortcut in the at least one convolution layer of trained first convolutional neural network, and merging the mergeable branch except the at least one first shortcut in the at least one convolution layer, and obtaining a second convolutional neural network having a first shortcut structure; and
performing quantization aware training based on the second convolutional neural network.

2. The quantization aware training method of claim 1, wherein the at least one first shortcut comprises a shortcut added in the first convolutional neural network, and/or an existing shortcut in the mergeable branch structure.

3. The quantization aware training method of claim 1, wherein if the at least one first shortcut comprises at least one shortcut added in the first convolutional neural network, the at least one shortcut is added in a way of:
for at least one convolution layer with a same input data dimension and output data dimension in the first convolution neural network, taking a result output from a previous convolution layer adjacent to this convolution layer as the at least one shortcut of this convolution layer, performing a first accumulation operation of this convolution layer on the at least one shortcut of this convolution layer and a result output from an activation function operation of this convolution layer, and inputting a result of the first accumulation operation to a next convolution layer adjacent to this convolution layer.

4. The quantization aware training method of claim 3, wherein the way for adding the at least one first shortcut further comprises:
taking a result output from this convolution layer as the at least one first shortcut of the next convolution layer adjacent to this convolution layer, performing a first accumulation operation of the next convolution layer on the at least one shortcut of this convolution layer and a result output from an activation function operation of the next convolution layer, and inputting a result of the first accumulation operation to a next convolution layer adjacent to the next convolution layer; and
recursing until the last convolution layer, so that each convolution layer with a same input data dimension and output data dimension in the first convolutional neural network has added first shortcut structure.

5. The quantization aware training method of claim 4, wherein a result output from the previous convolution layer is: a result output from a first accumulation operation performed on a result of an activation function operation in the previous convolution layer and at least one first shortcut in the previous convolution layer; and
a result output from this convolution layer is: a result output from the first accumulation operation performed on a result of the activation function operation in this convolution layer and the at least one first shortcut in this convolution layer.

6. The quantization aware training method of claim 4, wherein a result output from the previous convolution layer is: a result output from a second accumulation operation performed on a result output from a convolution operation and a mergeable branch structure in the previous convolution layer; and
a result output from this convolution layer is: a result output from a second accumulation operation performed on a result of a convolution operation and a mergeable branch structure in this convolution layer.

7. The quantization aware training method of claim 1, wherein the mergeable branch structure comprises a residual branch and/or a second shortcut,
for each convolution layer, a convolution operation is performed on input data, a second accumulation operation is performed on a result output from the convolution operation and the residual branch and/or the second shortcut, and an activation function operation is performed on a result output from the second accumulation operation.

8. The quantization aware training method of claim 7, wherein the at least one first shortcut comprises the second shortcut in the mergeable branch structure.

9. (canceled)

10. A convolutional neural network structure for quantization aware training, comprising at least one convolution layer, wherein in the at least one convolution layer:
an output result of a previous convolution layer adjacent to this convolution layer is taken as at least one first shortcut of this convolution layer and connected to an input of a first accumulation operation of this convolution layer, an output of an activation function operation of this convolution layer is connected to another input of the first accumulation operation of this convolution layer, and a result of the first accumulation operation is input to a next convolution layer adjacent to this convolution layer;
wherein the at least one first shortcut is: a shortcut reserved in merging a mergeable branch structure in sample-trained first convolutional neural network, wherein at least one convolution layer of the first convolutional neural network comprises the mergeable branch structure.

11. The convolutional neural network structure of claim 10, wherein the convolutional neural network structure further comprises:
a result output from this convolution layer is taken as at least one first shortcut of a next convolution layer adjacent to this convolution layer, and connected to an input of the first accumulation operation of the next convolution layer, an output of an activation function operation of the next convolution layer is connected to another input of the first accumulation operation in the next convolution layer, and a result of the first accumulation operation is input to a next convolution layer adjacent to the next convolution layer; and
recursively, each convolution layer with a same input data dimension and output data dimension has a first shortcut structure.

12. The convolutional neural network structure of claim 11, wherein a result output from the previous convolution layer is: a result output from a first accumulation operation performed on a result of an activation function operation in the previous convolution layer and at least one first shortcut in the previous convolution layer; and
a result output from this convolution layer is: a result output from the first accumulation operation performed on a result of the activation function operation in this convolution layer and the at least one first shortcut in this convolution layer.

13. The convolutional neural network structure of claim 12, wherein a result output from the previous convolution layer is: a result output from a second accumulation operation performed on a result output from a convolution operation and a mergeable branch structure in the previous convolution layer; and
a result output from this convolution layer is: a result output from the second accumulation operation performed on a result of a convolution operation and a mergeable branch in this convolution layer.

14. The convolutional neural network structure of claim 10, wherein the mergeable branch structure comprises a residual branch and/or a second shortcut,
for each convolution layer, a convolution operation is performed on input data, a second accumulation operation is performed on a result output from the convolution operation and the residual branch and/or the second shortcut, and an activation function operation is performed on a result output from the second accumulation operation.

15. The convolutional neural network structure of claim 14, wherein the at least one first shortcut comprises a second shortcut in the mergeable branch structure.

16. A computer-readable storage medium comprising a stored program, wherein the program, when executed by a computer, performs a quantization aware training method for a convolutional neural network, the method comprising:
performing sample training on a first convolutional neural network, wherein at least one convolution layer of the first convolutional neural network comprises a mergeable branch structure and at least one first shortcut;
reserving the at least one first shortcut in the at least one convolution layer of trained first convolutional neural network, and merging the mergeable branch except the at least one first shortcut in the at least one convolution layer, and obtaining a second convolutional neural network having a first shortcut structure; and
performing quantization aware training based on the second convolutional neural network.

17. (canceled)

18. (canceled)
